(19) United States
(12) Patent Application Publication
(10) Pub. No.: US 2012/0154859 A1
(43) Pub. Date: Jun. 21, 2012

(54) IMAGE PROCESSING APPARATUS, SERVER APPARATUS, CONTROL METHOD THEREOF, AND STORAGE MEDIUM THEREFOR

(75) Inventor: Junichi Goda, Kawasaki-shi (JP)

(73) Assignee: CANON KABUSHIKI KAISHA, Tokyo (JP)

(21) Appl. No.: 13/312,866

(22) Filed: Dec. 6, 2011

(30) Foreign Application Priority Data
Dec. 15, 2010 (JP) 2010-279886

(51) Int. Cl. G06K 15/02

(52) U.S. Cl. 358/1.15

(57) ABSTRACT

In an image processing apparatus, preparation processing instruction information is received from an external apparatus before a processing unit executes an image processing function so that preparation processing is performed on the processing unit based on the preparation processing instruction information.

### BACKGROUND OF THE INVENTION

1. Field of the Invention

The present invention relates to an image processing apparatus, a server apparatus, a control method thereof, and a storage medium therefor.

2. Description of the Related Art

Some recent multi-function peripherals (MFPs) are each equipped with a Web browser as well as a scanner and a printer. Such MFPs each display an operation screen provided by a Web server on the Web browser thereof to accept various instructions from users.

In addition, related techniques have been developed such as that discussed in Japanese Patent Application Laid-Open No. 2008-003833. Japanese Patent Application Laid-Open No. 2008-003833 discusses a Web server of an MFP that provides an operation screen via which a user can input an instruction to use functions of the MFP. In other words, a user of the MFP inputs an instruction to the MFP via the operation screen displayed on the Web browser. The input instruction is provided to the Web server by the Web browser.

The notified Web server requests the MFP to execute various types of processing according to the instruction input by the user. Upon receipt of the request, the MFP executes the requested processing. Such configuration eliminates the necessity of storing every menu data to operate the MFP within the MFP, and facilitates changes of the menu data performed on the Web server.

Some MFPs are known to operate in one of a normal power mode and a power saving mode that consumes less power than that in the normal power mode (e.g., Japanese Patent Application Laid-Open No. 2008-205714). Such MFPs provide an advantage of power saving by stopping power supply to processing units incorporated therein when the MFPs are not used for a long period of time.

As discussed in Japanese Patent Application Laid-Open No. 2008-205714, when a job is executed in an MFP operating in the power saving mode, a process to switch the MFP to the normal power mode is implemented after acceptance of an instruction for the process at the MFP. Accordingly, it takes time to switch the MFP to the normal power mode after the acceptance of the instruction from a user, resulting in a delay in starting the job.

In the cases where a user instructs execution of a process via an operation screen displayed on a Web browser as discussed in Japanese Patent Application Laid-Open No. 2008-003833, the Web server detects the instruction from the user, and then transmits a request to the MFP to execute the process. It takes more time than the above case until start of the job after input of the instruction from the user.

### SUMMARY OF THE INVENTION

The present invention relates to decreasing the time required to execute an image processing function in an image processing apparatus that executes the image processing function based on an execution instruction generated in an external apparatus in response to an operation by a user at an operation screen of the external apparatus.

According to an aspect of the present invention, an image processing apparatus having an image processing function includes a control unit, at least one image processing unit configured to execute the image processing function, an interface unit configured to acquire screen information from an external apparatus, and an operation unit configured to display an operation screen based on the screen information, where the interface unit is further configured to receive, from the external apparatus, preparation processing instruction information instructing performance of preparation processing so that the at least one image processing unit executes the image processing function, where the control unit is configured to perform preparation processing based on the preparation processing instruction information, where the interface unit is further configured to receive, after the control unit starts the preparation processing, an execution instruction that instructs performance of the image processing function from the external apparatus, the instruction generated by the external apparatus in response to an operation input by a user via the operation screen, and where the at least one image processing unit executes the image processing function based on the execution instruction.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an image processing system of a first exemplary embodiment according to the present invention.

FIG. 2 illustrates a configuration of an MFP of the first exemplary embodiment according to the present invention.

FIG. 3 is a block diagram illustrating a configuration of a Web server of the first exemplary embodiment according to the present invention.

FIG. 4 is a block diagram illustrating a software configuration of an image processing system of the first exemplary embodiment according to the present invention.

FIG. 5 is a flowchart illustrating a processing procedure executed on the MFP of the first exemplary embodiment according to the present invention.

FIGS. 6A to 6D each illustrate an example of an operation screen of the first exemplary embodiment according to the present invention.

FIG. 7 is a flowchart illustrating a processing procedure executed on the Web server of the first exemplary embodiment according to the present invention.

FIGS. 8A and 8B are each a preparation processing instruction list of the first exemplary embodiment according to the present invention.

FIG. 9 is a flowchart illustrating a processing procedure executed on the MFP of the first exemplary embodiment according to the present invention.

FIG. 10 is a flowchart illustrating a processing procedure executed on the Web server of the first exemplary embodiment according to the present invention.

FIG. 11 is a block diagram illustrating a software configuration of an image processing system of a second exemplary embodiment according to the present invention.

### DESCRIPTION OF THE EMBODIMENTS

Various exemplary embodiments, features, and aspects of the invention will be described in detail below with reference to the drawings.

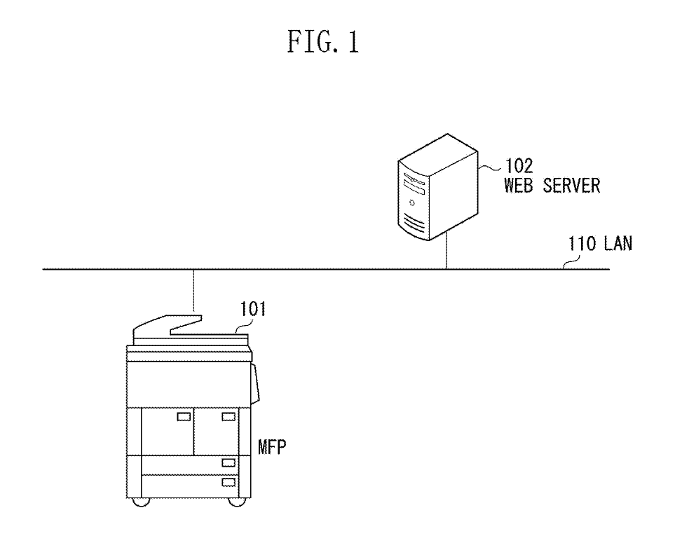

FIG. 1 illustrates an image processing system of a first exemplary embodiment.

A local area network (LAN) 110 connects an MFP 101 and a Web server 102 to be in communication with one another. The system of the present exemplary embodiment can be achieved even when the MFP 101 is connected to the Web server 102 in a way other than the LAN 110, such as the Internet or a wireless communication. The MFP 101 is used as an example of an image processing apparatus, but an image processing apparatus according to the present invention may be another apparatus such as a single function peripheral (SFP) including a scanner or a printer, and a personal computer (PC). The Web server 102 is used as an example of an external apparatus, but an external apparatus according to the present invention may be another apparatus such as an MFP and a PC that have a Web server function.

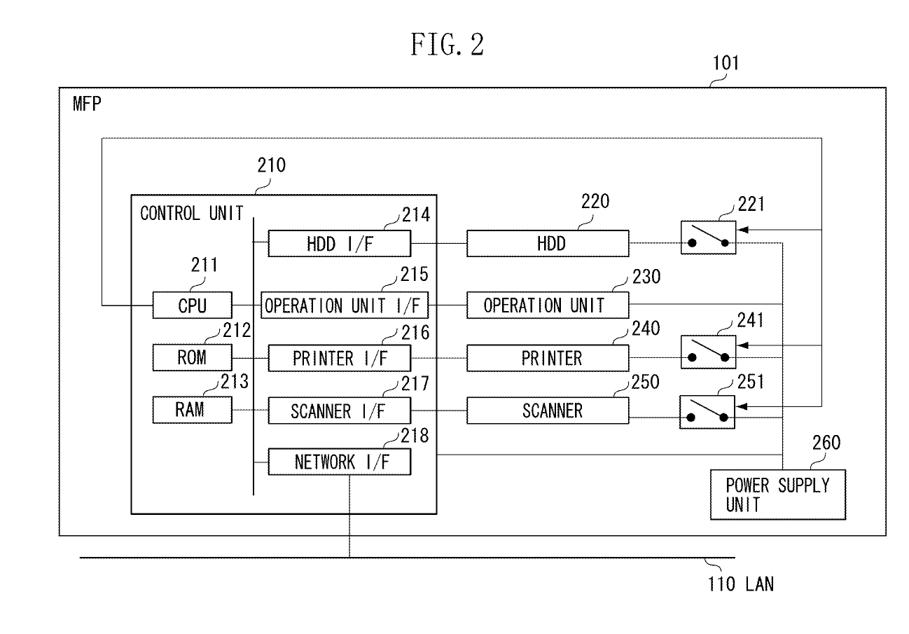

FIG. 2 is a block diagram illustrating a hardware configuration of the MFP 101. A control unit 210 includes a central processing unit (CPU) 211, and controls the entire MFP 101. The CPU 211 reads a control program to execute processing that is illustrated in each of the below described flowcharts and stored in a read only memory (ROM) 212, and executes various types of control processing, for example, reading control and transmission control. A random access memory (RAM) 213 is used as a main memory and a temporary storage area such as a work area of the CPU 211.

A hard disk drive interface (HDD I/F) 214 connects a HDD 220 to the control unit 210. The HDD 220 stores therein control programs to execute processing illustrated in the below described flowcharts, and image data to be displayed on an operation unit 230, similar to the ROM 212.

An operation unit I/F 215 connects the operation unit 230 to the control unit 210. The operation unit 230 is provided with a liquid crystal display unit having a touch panel function, and a key board. The MFP 101 is provided with a below described Web browser function, so that the Web browser of the MFP 101 can analyze a hypertext markup language (HTML) file received from the Web server 102, and display an operation screen based on the description of the HTML file on the liquid crystal display unit of the operation unit 230.

A printer I/F 216 connects a printer 240 to the control unit 210. Image data to be printed by the printer 240 is transferred via the printer I/F 216 from the control unit 210, so that the printer 240 can print the image data on a recording medium such as paper.

A scanner I/F 217 connects a scanner 250 to the control unit 210. The scanner 250 reads a document to generate corresponding image data, which is input to the control unit 210 via the scanner I/F 217.

A power supply unit 260 supplies power to the control unit 210, the HDD 220, the operation unit 230, the printer 240, and the scanner 250 to operate each of them. Among these units, the HDD 220, the printer 240, and the scanner 250 are provided with switches 221, 241, and 251 respectively, so that the CPU 211 can control the switches to control power supply from the power supply unit 260 to each of the processing units.

The MFP 101 can operate in one of a normal power mode and a power saving mode that consumes less power than the normal power mode. While operating in the power saving mode, the MFP 101 stops power supply to predetermined processing units (e.g., the HDD 220, the printer 240, and the scanner 250).

According to the present exemplary embodiment, power is supplied to the control unit 210 and the operation unit 230 while the MFP 101 operates in the power saving mode, however, for example, power supply to the CPU 211 may be stopped when the MFP 101 enters the power saving mode. In this case, another CPU is required in the MFP 101 to control the operation unit 230 and the network I/F 218 to which power is supplied during the power saving mode, and to cause the MFP 101 to return to the normal power mode.

The power saving may be achieved by means other than the above power supply. For example, the clock frequency supplied to the CPU 211 may be lowered to save power.

A network I/F 218 connects the control unit 210 (i.e., the MFP 101) to the LAN 110. The network I/F 218 transmits image data and information to an external apparatus (e.g., the Web server 102) within the LAN 110, and receives information from the external apparatus within the LAN 110.

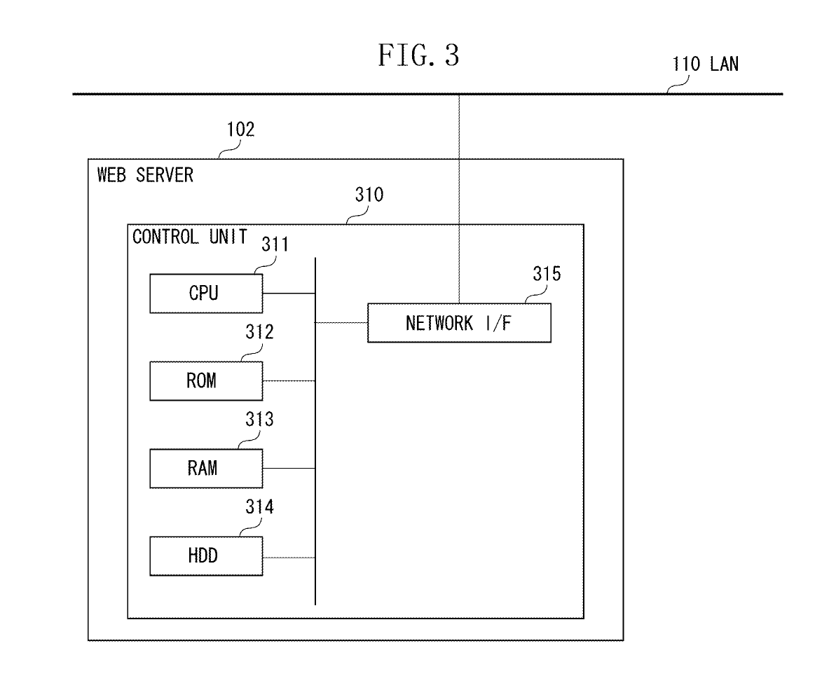

FIG. 3 is a block diagram illustrating a hardware configuration of the Web server 102. A control unit 310 includes a CPU 311, and controls the entire Web server 102. The CPU 311 reads a control program to execute processing which is illustrated in each of the below described flowcharts and stored in a ROM 312, and executes various types of control processing.

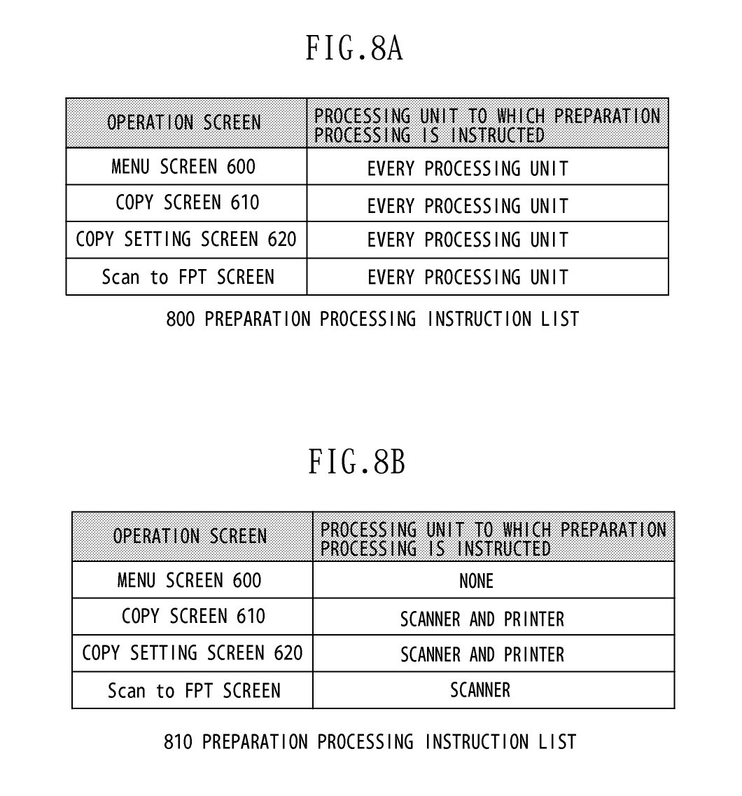

A RAM 313 is used as a main memory and a temporary storage area such as a work area of the CPU 311. An HDD 314 stores therein control programs to execute processing illustrated in the below described flowcharts, and preparation processing instruction lists illustrated in FIGS. 8A and 8B, similar to the ROM 312.

A network I/F 315 connects the control unit 310 (i.e., the Web server 102) to the LAN 110. The network I/F 315 transmits and receives information to/from other apparatuses within the LAN 110.

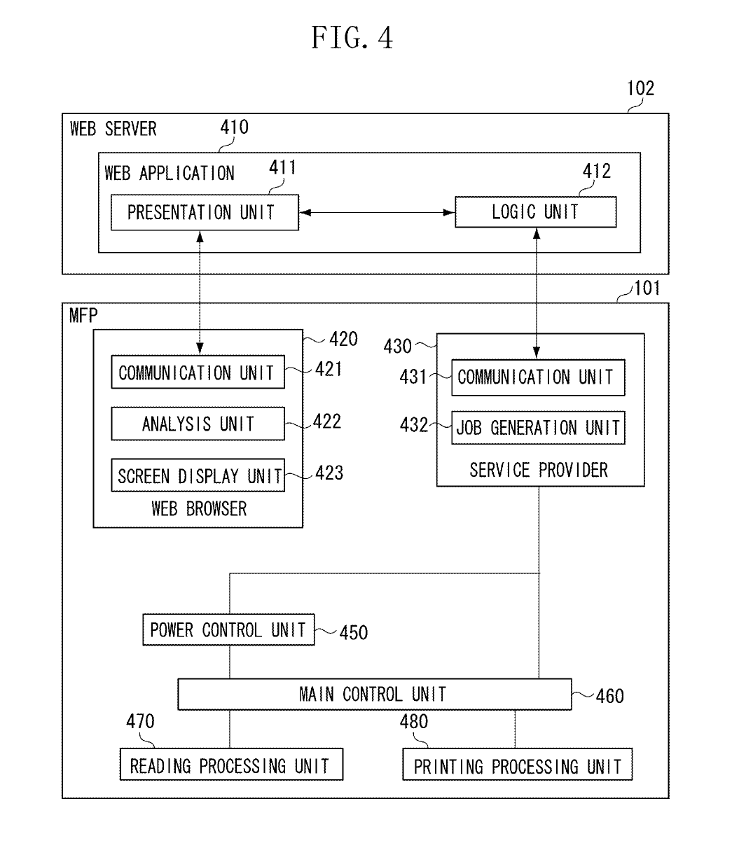

FIG. 4 illustrates a software configuration of the image processing system according to the present exemplary embodiment. The software functions in FIG. 4 are implemented when the CPUs of the MFP 101 and the Web server 102 respectively execute control programs.

A software configuration of the MFP 101 will now be described.

A Web browser 420 includes a communication unit 421, an analysis unit 422, and a screen display unit 423. The communication unit 421 communicates with a presentation unit 411 of a Web application 410 via the network I/F 218 according to a hypertext transfer protocol (HTTP) protocol. More specifically, the communication unit 421 requests the Web application 410 for an operation screen to be displayed on the Web browser 420, and notifies the Web application 410 of an instruction content input from a user via the operation screen.

The analysis unit 422 analyzes an HTML file received from the Web application 410 via the network I/F 218. The HTML file contains description of contents of the operation screen to be displayed on the Web browser. The screen display unit 423 displays an operation screen on the operation unit 230 based on the result analyzed by the analysis unit 422.

A service provider 430 includes a communication unit 431 and a job generation unit 432. The communication unit 431 receives an execution instruction of an image processing function from a logic unit 412 of the Web application 410 via the network I/F 218. Upon receipt of the execution instruction from the Web application 410, the job generation unit 432 generates and executes a job to execute the image processing function corresponding to the execution instruction. The service provider 430 also receives a preparation processing instruction information from the logic unit 412, the information instructing to execute a preparation processing on the processing unit. According to the present exemplary embodiment, preparation processing of the processing unit is performed based on the preparation processing instruction information.

Preparation processing according to the present exemplary embodiment refers to processing to set a state of the processing unit to a state where the image processing function can be realized. According to the present exemplary embodiment, the preparation processing is defined as a switch of the predetermined processing unit from the power saving mode to the normal power mode.

In the power saving mode, power supply to the predetermined processing units such as the printer 240 and the scanner 250 is stopped. Thus, to switch the modes, the switches 241 and 251 are turned on to resume power supply to the printer 240 and the scanner 250. The switching from the power saving mode to the normal power mode before the service provider 430 receives an execution instruction from the logic unit 412 (e.g., while the operation screen is displayed) enables an earlier execution of the image processing function corresponding to the execution instruction.

The switching from the power saving mode to the normal power mode is only illustrative of the preparation processing, and another approach may be used to execute earlier the image processing function corresponding to an execution instruction. Examples of the approach include shifting the scanner 250 to a reading start position, heating a fixing roller (not illustrated) of the printer 240 to a predetermined temperature, and the like.

According to the present exemplary embodiment, the approach to be selected among the above described above plurality of approaches as a preparation processing is determined based on a command predetermined between the MFP 101 and the Web server 102. The processing unit on which the preparation processing is performed is also determined based on information contained in the command and indicating a specific processing unit.

As illustrated in FIG. 4, the MFP 101 further includes a reading processing unit 470 that reads a document using the scanner 250, and a printing processing unit 480 that executes printing using the printer 240. A main control unit 460 controls each unit of the MFP 101, and also controls the switches 221, 241, and 251 according to instructions from a power control unit 450 to switch power modes. The power control unit 450 instructs the main control unit 460 to switch each of the switches 221, 241, and 251.

A software configuration of the Web server 102 will now be described. The Web server 102 is provided with the Web application 410 including the presentation unit 411 and the logic unit 412.

The presentation unit 411 communicates with the communication unit 421 via the network I/F 315, and transmits an operation screen to be displayed on the Web browser of the MFP 101 thereto in response to a request from the MFP 101. The presentation unit 411 also receives an instruction from the MFP 101, which is input by a user via the operation screen displayed on the Web browser of the MFP 101.

Upon receipt of the instruction from the user, the Web application 410 executes various types of processing corresponding to the instruction, and requests the MFP 101 to execute the processing if needed. More specifically, the logic unit 412 generates an execution instruction of the image processing function and transmits the instruction to the MFP 101 to request the MFP 101 to execute printing using the printer 240, to execute reading with the scanner 250, or to perform transmission via the network I/F 218.

When the Web application 410 requests the MFP 101 to execute the processing, the logic unit 412 communicates with the communication unit 431 in the service provider 430 of the MFP 101 via the network I/F 315. The logic unit 412 communicates with the communication unit 431 using a Simple Object Access Protocol (SOAP) protocol. The above-described command with respect to the preparation processing on the processing unit is transmitted from the logic unit 412 to the service provider 430 using the SOAP protocol.

The system of the present exemplary embodiment has a structure as described above. A process flow in the system according to the present exemplary embodiment is described next.

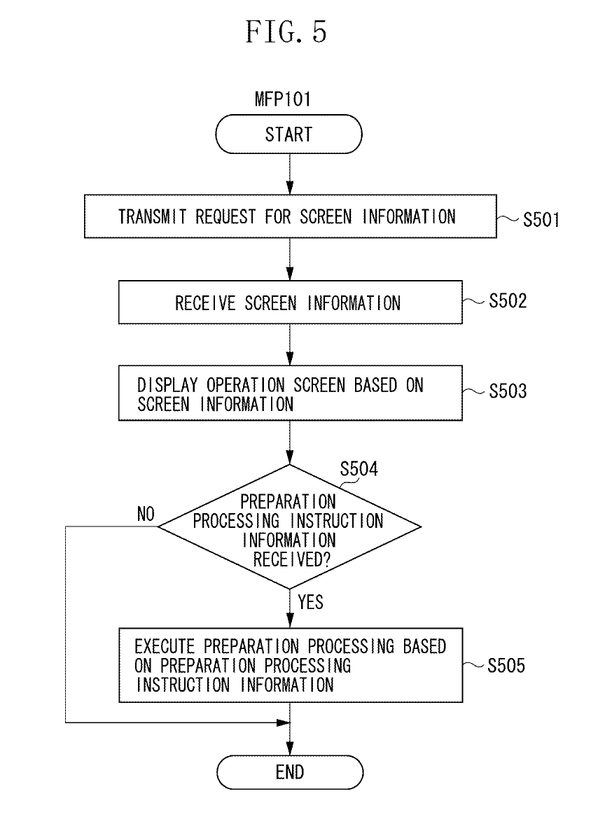

FIG. 5 is a flowchart illustrating a processing procedure executed by the MFP 101 in the present exemplary embodiment when a screen transition on the operation screen displayed on the operation unit 230 occurs through an operation by a user and the Web browser 420 requests the Web application 410 for screen information corresponding to the screen transition.

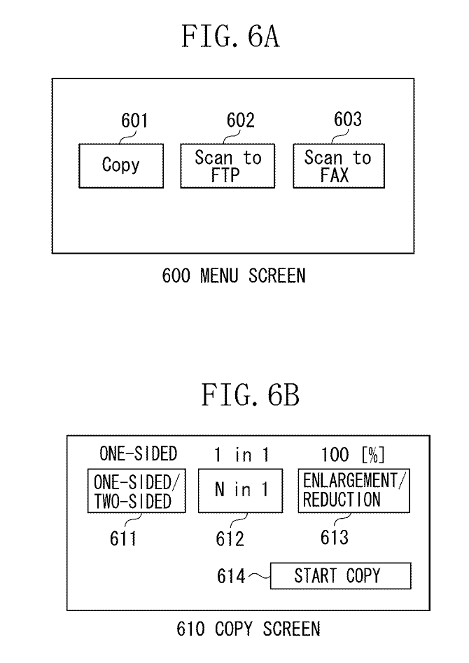

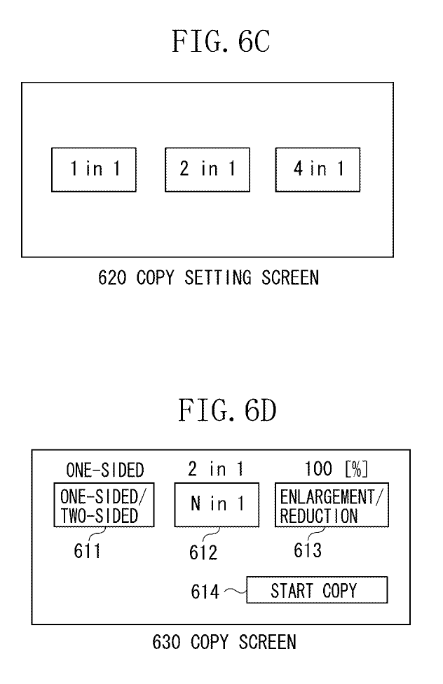

The processing procedure in the present flowchart is executed every time when screen transition occurs on the operation screen displayed on the operation unit 230 by the Web browser 420 (e.g., the operation screen in FIG. 6). Each processing in steps S501 to S505 is implemented when the CPU 211 of the MFP 101 loads a program stored in a memory such as the ROM 212 to the RAM 213 and executes it.

In step S501, the Web browser 420 transmits a request for screen information to the Web application 410 via the network I/F 218. In step S502, the Web browser 420 receives the screen information to be displayed on the operation unit 230 from the Web application 410 via the network I/F 218. In step S503, the Web browser 420 displays the operation screen on the operation unit 230 based on the received screen information.

FIG. 6A illustrates an example of the operation screen displayed in step S503.

A menu screen 600 in FIG. 6A is an operation screen displayed on the operation unit 230 via which a user can select a function. For example, a user can use a copy function by pressing a button 601. A user can press a button 602 to use a Scan to file transfer protocol (FTP) function for FTP transmission of image data obtained via scanning processing. A user can press a button 603 to use a Scan to facsimile (FAX) function for FAX transmission of image data obtained via scanning processing.

A copy screen 610 in FIG. 6B is an operation screen displayed on the operation unit 230 when the button 601 is pressed by a user on the menu screen 600. A user can make settings of one-sided/two-sided scanning, N in 1, and enlargement/reduction by pressing buttons 611 to 613 respectively on the copy screen 610. Copying processing starts when a user presses an execution button 614.

A copy setting screen 620 in FIG. 6C is an operation screen displayed on the operation unit 230 when a user presses the button 611 on the copy screen 610. A user can select one of “1 in 1”, “2 in 1”, and “4 in 1” as the N in 1 setting, on the copy setting screen 620.

When a user selects “2 in 1” on the copy setting screen 620, a copy screen 630 in FIG. 6D is displayed on the operation unit 230. The copy screen 630 differs from the copy screen 610 in the item “2 in 1” selected by a user for the N in 1 setting.

Returning to the description of the flowchart in FIG. 5, in step S504, the CPU 211 determines whether the service provider 430 has received preparation processing instruction information to perform preparation processing on the processing unit from the logic unit 412 of the Web application 410.

When the CPU 211 determines that the service provider 430 has not received preparation processing instruction information (NO in step S504), the processing of the present flowchart ends. When the CPU 211 determines that the service provider 430 has received preparation processing instruction information (YES in step S504), the processing proceeds to step S505.

In step S505, the preparation processing is performed on the processing unit based on the preparation processing instruction information received in step S504. More specifically, first, the service provider 430 analyzes a command included in the received preparation processing instruction information. Then, if the preparation processing instruction information indicates power supply to the printer 240, the CPU 211 turns on the switch 241 to start power supply to the printer 240.

When the preparation processing instruction information received in step S504 indicates heating of the fixing roller of the printer 240 to a predetermined temperature, the CPU 211 controls heating of the fixing roller of the printer 240 to the predetermined temperature.

Thus, before receipt of the execution instruction of the image processing function, the fixing roller of the printer 240 can be controllably heated as the preparation processing. Accordingly, the image processing function based on the execution instruction can be executed earlier than the case the fixing roller of the printer 240 is controllably heated after receipt of the execution instruction. According to the present exemplary embodiment, a plurality of preparation processing can be combined.

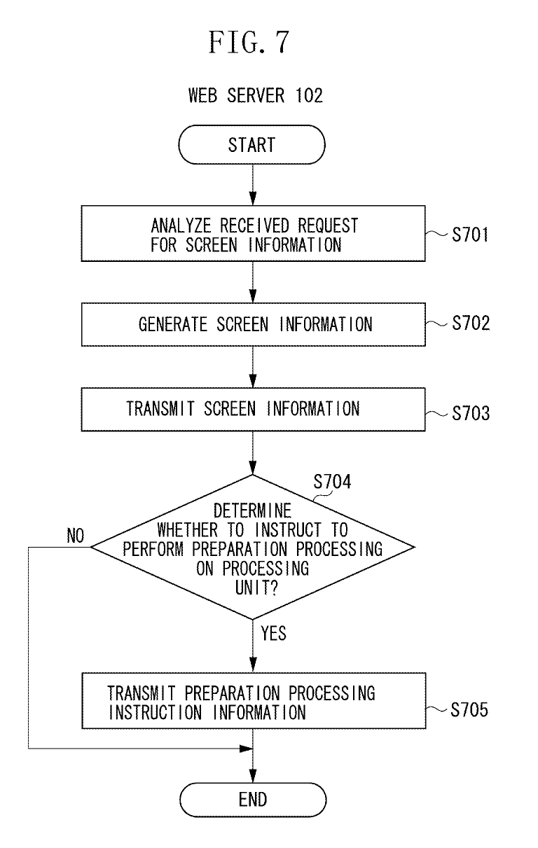

FIG. 7 is a flowchart illustrating a processing procedure executed by the Web server 102 that receives a request for screen information from the MFP 101 in step S501 in FIG. 5. Each processing in steps S701 to S705 is implemented when the CPU 311 of the Web server 102 loads a program stored in a memory such as the ROM 312 to the RAM 313, and executes it.

In step S701, the presentation unit 411 analyzes a request for screen information that is received via the network I/F 315.

In step S702, according to the analysis result in step S701, the presentation unit 411 generates screen information to be transmitted to the MFP 101. More specifically, when the Web browser requests for the copy screen 610, the presentation unit 411 generates screen information (e.g., an HTML file) that is used to display the copy screen 610.

In step S703, the presentation unit 411 transmits the screen information generated in step S702 to the Web browser 420 via the network I/F 315. According to the present exemplary embodiment, the presentation unit 411 generates screen information, however the presentation unit 411 may transmit screen information prepared in advance in the HDD 314 or the ROM 312 of the Web server 102, instead of generation of the screen information.

In step S704, the CPU 311 determines whether to instruct the MFP 101 to perform preparation processing on the processing unit via the operation screen displayed based on the screen information transmitted in step S703. The determination is based on preparation processing instruction lists 800 and 810 respectively illustrated in FIGS. 8A and 8B.

The preparation processing instruction lists 800 and 810 respectively illustrated in FIGS. 8A and 8B will now be described. The preparation processing instruction lists 800 and 810 each include the processing units on which the MFP 101 is instructed to perform preparation processing, with respect to the operation screen displayed based on the screen information generated by the Web server 102. The preparation processing instruction lists 800 and 810 illustrated in FIGS. 8A and 8B are stored in the ROM 312 or the HDD 314 of the Web server 102.

In the preparation processing instruction list 800, every processing unit is set as a unit on which the preparation processing is performed by the MFP 101 with respect to each of the listed operation screens. This type of setting is for the cases where an image processing function is supposed to be executed when a user requests screen information, and the preparation processing is performed on every processing unit in advance of the execution of the image processing function, so that the image processing function starts immediately in response to an instruction from the user.

According to the present exemplary embodiment, power supply to the processing unit is executed as the preparation processing, however some users desire to save power by keeping the power saving mode without supplying power to the processing unit as long as possible. The preparation processing instruction list 810 illustrates settings that respond to such desire.

In the preparation processing instruction list 810, no processing unit is set for the menu screen 600 as a unit to which performance of the preparation processing is instructed, because it is uncertain which image processing function a user may select. Through the copy screen 610 and the copy setting screen 620, it is certain that the scanner and the printer are used for copy processing. Accordingly, the scanner and the printer are set as processing units to which performance of the preparation processing is instructed.

Via a Scan to FTP screen (not illustrated), image data generated by reading using the scanner 250 is transmitted via FTP. Accordingly, the scanner is set as the processing unit to which performance of the preparation processing is instructed. In this case, printing is not executed by the printer 240, so that the printer is not set as the processing unit to which performance of the preparation processing is instructed.

Based on the settings in the preparation processing instruction list 810, power can be supplied only to the processing unit related to the current operation screen as the preparation processing, and not to the processing unit unrelated to the operation screen. Accordingly, more power saving can be achieved than in the case with the settings in the preparation processing instruction list 800.

A user (e.g., a manager of the Web server 102) can choose a way of settings between those in the preparation processing instruction list 800 and those in the preparation processing instruction list 810 for more power saving.

Returning to the description of the flowchart in FIG. 7. In step S704, the CPU 311 determines whether to instruct the MFP 101 to perform the preparation processing on the processing unit related to the operation screen displayed based on the screen information transmitted in step S703. According to the present exemplary embodiment, the CPU 311 makes the determination based on the preparation processing instruction list 810.

In the case where the screen information to display the menu screen 600 is transmitted in step S703, there is no processing unit to which performance of the preparation processing is instructed according to the preparation processing instruction list 810. Therefore, in step S704, the CPU 311 determines not to instruct the MFP 101 to perform the preparation processing on any processing unit (NO in step S704), and the processing in the present flowchart ends.

In the case where the screen information to display the copy screen 610 is transmitted in step S703, the scanner 250 and the printer 240 are the processing units to which performance of the preparation processing is instructed according to the preparation processing instruction list 810. Therefore, in step S704, the CPU 311 determines to instruct the MFP 101 to perform the preparation processing on these processing units (YES in step S704), and the processing proceeds to step S705.

In step S705, based on the determination in step S704, the logic unit 412 of the Web server 102 transmits the preparation processing instruction information to the service provider 430 of the MFP 101. The transmitted preparation processing instruction information contains a command that specifies the preparation processing performed by the MFP 101. More specifically, a command to supply power to the scanner 250 and the printer 240 as the preparation processing is contained in the preparation processing instruction information transmitted in step S705. After the transmission of the preparation processing instruction information to the service provider 430 via the network I/F 315 by the logic unit 412 in step S705, the processing in the present flowchart ends.

According to the present exemplary embodiment, a way to perform the preparation processing by the MFP 101 is determined by the preparation processing instruction information transmitted to the MFP 101 by the Web server 102, however the following control may be performed instead. The preparation processing instruction information may contain a command that specifies the processing unit on which the preparation processing is performed, but not contain a command that specifies a way to perform the preparation processing. In this case, the service provider 430 performs the preparation processing that is set in advance in the MFP 101 on the processing unit instructed by the preparation processing instruction information.

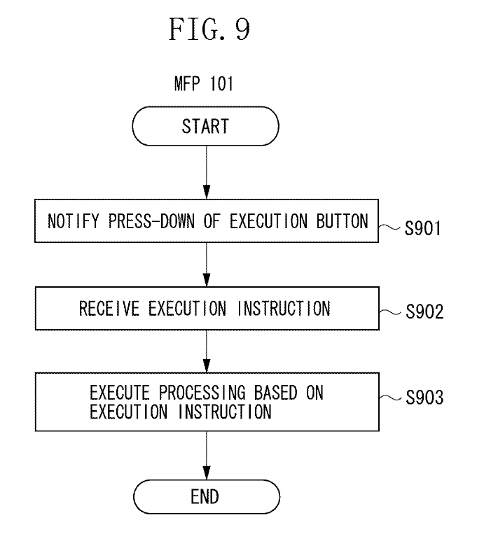

FIG. 9 is a flowchart illustrating a processing procedure executed when performance of an image processing function is instructed by a user via the operation screen displayed on the operation unit 230 by the Web browser 420. Each processing in steps S901 to S903 is implemented when the CPU 211 of the MFP 101 executes a program stored in a memory such as the ROM 212 by loading the program to the RAM 213.

The present flowchart is described by way of an example where the copy screen 610 is displayed on the operation unit 230, and a user inputs settings for copying and presses the execution button 614. In step S901, the Web browser 420 notifies the Web application 410, via the network I/F 218, that the execution button 614 was pressed and the information indicating the copy settings input by the user.

In step S902, the service provider 430 receives an execution instruction of the image processing function corresponding to the notification in step S901, via the network I/F 218 from the Web application 410.

In step S903, the service provider 430 executes the image processing function based on the execution instruction received in step S902. In the present flowchart, reading with the scanner 250 and printing by the printer 240 are executed to achieve copying processing.

As described above, before receipt of an execution instruction of an image processing function, preparation processing (e.g., power supply to the printer 240 and the scanner 250) can be performed. Accordingly, the image processing function based on the execution instruction can be executed earlier than the case where the preparation processing starts after receipt of the execution instruction.

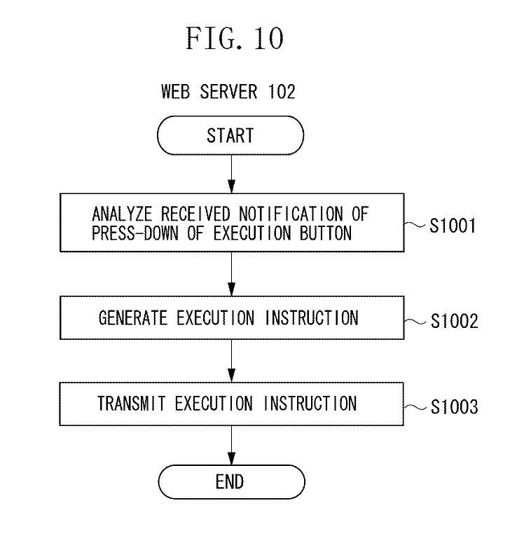

FIG. 10 is a flowchart illustrating processing executed by the Web server 102 that received the notification from the MFP 101 in step S901 in FIG. 9. Each processing in steps S1001 to S1003 is implemented when the CPU 311 of the Web server 102 executes a program stored in a memory such as the ROM 312 by loading the program to the RAM 313.

The present flowchart is described by way of an example where the copy screen 610 is displayed on the operation unit 230 of the MFP 101, and a user inputs settings for copying and presses the execution button 614, as in the flowchart in FIG. 9.

In step S1001, the presentation unit 411 of the Web application 410 analyzes the notification received from the Web browser 420 via the network I/F 315.

In step S1002, in response to the analysis result in step S1001, the logic unit 412 of the Web application 410 generates an execution instruction of an image processing function to be transmitted to the service provider 430. In the present flowchart, the execution instruction to cause the MFP 101 to execute reading with the scanner 250 and printing with the printer 240 to achieve copying processing is generated.

In step S1003, the logic unit 412 transmits the execution instruction of the image processing function generated in step S1002 via the network I/F 315 to the service provider 430.

As described above, according to the present exemplary embodiment, performance of preparation processing on a target processing unit can be started before an image processing function is executed by the processing unit based on an execution instruction generated by the Web server 102 in response to an operation input by a user via an operation screen. Consequently, the time necessary for execution of an image processing function can be reduced as compared with the case where preparation processing is executed after receipt of an execution instruction.

In the first exemplary embodiment, the Web application 410 communicates with both the Web browser 420 and the service provider 430. A second exemplary embodiment embeds an execution instruction of an image processing function to be transmitted to the service provider 430 and prepares processing instruction information as a script in a response to the Web browser 420, and transmitting the response to the Web browser 420.

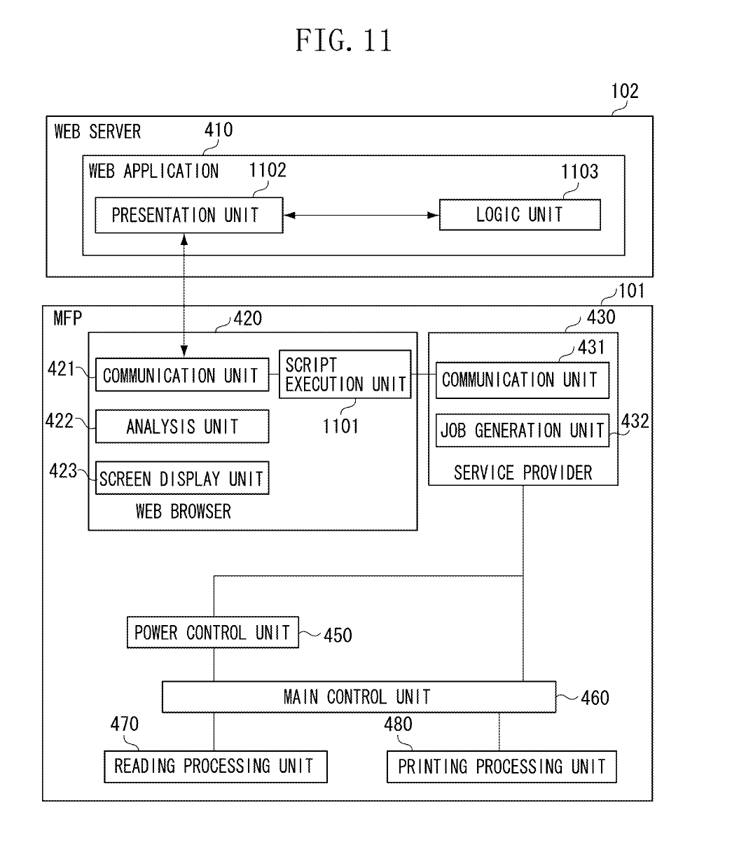

FIG. 11 a block diagram illustrating a software configuration of an image processing system of the second exemplary embodiment. The software functions in FIG. 11 are implemented by the CPUs respectively provided in the MFP 101 and the Web server 102 in FIGS. 2 and 3 executing a control program. The units in FIG. 11 designated with the same reference numerals as those in FIG. 4 are similar to the units in FIG. 4, and are not described herein.

A presentation unit 1102 receives a notification of an instruction input by a user via the Web browser 420, from the Web browser 420 via the network I/F 315. A logic unit 1103 embeds an execution instruction of an image processing function or preparation processing instruction information that corresponds to the notification as a script into an HTTP response to be transmitted by the presentation unit 1102 to the Web browser 420. The presentation unit 1102 then transmits the HTTP response via the network I/F 315 to the Web browser 420.

A script execution unit 1101 of the Web browser 420 executes the script embedded in the HTTP response, and transmits the execution instruction of the image processing function or the preparation processing instruction information to the service provider 430 according to the execution result of the script. The service provider 430 performs processing as in the first exemplary embodiment, based on the execution instruction of the image processing function or the preparation processing instruction information received thereby.

As described above, according to the present exemplary embodiment, communication between the Web application 410 and the service provider 430 is contained in an HTTP response transmitted to the Web browser 420. Consequently, if, for example, a firewall exists between the Web server 102 and the MFP 101, a communication therebetween can be established.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable storage

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-279886 filed Dec. 15, 2010, which is hereby incorporated by reference herein in its entirety.

What is claimed is:

1. An image processing apparatus having an image processing function, the image processing apparatus comprising:
a control unit;
at least one image processing unit configured to execute the image processing function;
an interface unit configured to acquire screen information from an external apparatus; and
an operation unit configured to display an operation screen based on the screen information,
wherein the interface unit is further configured to receive, from the external apparatus, preparation processing instruction information instructing performance of preparation processing so that the at least one image processing unit executes the image processing function,
wherein the control unit is configured to perform preparation processing based on the preparation processing instruction information,
wherein the interface unit is further configured to receive, after the control unit starts the preparation processing, an execution instruction that instructs performance of the image processing function from the external apparatus, the instruction generated by the external apparatus in response to an operation input by a user via the operation screen, and
wherein the at least one image processing unit executes the image processing function based on the execution instruction.

2. The image processing apparatus according to claim 1, wherein the at least one image processing unit operates in a normal power mode or a power saving mode, and
wherein the preparation processing comprises the at least one image processing unit being switched from the power saving mode to the normal power mode.

3. The image processing apparatus according to claim 1, wherein the preparation processing instruction information includes information indicating the at least one image processing unit on which the preparation processing is performed.

4. The image processing apparatus according to claim 1, wherein the preparation processing instruction information includes information indicating contents of processing performed as the preparation processing.

5. The image processing apparatus according to claim 1, wherein the preparation processing instruction information is acquired by the interface unit together with the screen information.

6. The image processing apparatus according to claim 1, wherein the at least one image processing unit is any one of a printing unit configured to perform printing based on image data and a reading unit configured to read a document and generate image data.

7. A server capable of communicating with an image processing apparatus including at least one image processing unit configured to execute an image processing function, the server comprising:
an interface unit; and
a central processing unit, connected to the interface unit via a bus, wherein the control unit is configured to:
receive, via the interface unit, a processing request from the image processing apparatus;
transmit, if the processing request is a request for screen information, via the interface unit to the image processing apparatus, screen information corresponding to the request for screen information and preparation processing instruction information instructing performance of preparation processing, and
transmit, if the processing request is a request indicating that execution of the image processing function is instructed by an operation of a user at the image processing apparatus, via the interface unit to the image processing apparatus, an execution instruction for instructing execution of the image processing function.

8. The server according to claim 7, wherein the preparation processing instruction information includes information indicating the at least one image processing unit on which the preparation processing is performed.

9. The server according to claim 7, wherein the preparation processing instruction information includes information indicating contents of processing performed as the preparation processing.

10. The server according to claim 7, wherein the preparation processing instruction information includes information for switching the at least one image processing unit from a power saving mode to normal power mode.

11. A method for controlling an image processing apparatus having an image processing function, the method comprising:
acquiring screen information from an external apparatus;
displaying an operation screen based on the screen information;
receiving from the external apparatus, preparation processing instruction information instructing performance of preparation processing so that the image processing function is executed;
performing preparation processing based on the preparation processing instruction information;
receiving, after the preparation processing begins, an execution instruction instructing performance of the image processing function from the external apparatus, the instruction being generated by the external apparatus in response to an operation input by a user via the operation screen; and
executing the image processing function based on the execution instruction.

12. A computer-readable storage medium storing a program for causing a computer to execute the method of claim 11.

13. A method for controlling a server capable of communicating with an image processing apparatus including at least one image processing unit configured to execute an image processing function, the method comprising:
receiving a processing request from the image processing apparatus;
transmitting, if the processing request is a request for screen information, to the image processing apparatus screen information corresponding to the request for screen information and preparation processing instruction information instructing performance of preparation processing so that the image processing function is executed; and
transmitting to the image processing apparatus, if the processing request is a request indicating that execution of the image processing function is instructed by an operation of a user at the image processing apparatus, an execution instruction for instructing execution of the image processing function.

14. A computer-readable storage medium storing a program for causing a computer to execute the method according to claim 13.
